(19) United States
(12) Patent Application Publication
(10) Pub. No.: US 2026/0310643 A1
(43) Pub. Date: Oct. 8, 2026

(54) MULTI-DIMENSIONAL DETECTION OF DATA CLEANUP TARGETS

(71) Applicant: SAP SE, Walldorf (DE)

(72) Inventors: Dominik Ofenloch, Lampertheim (DE); Susanne Schott, Walldorf (DE)

(21) Appl. No.: 19/173,058

(22) Filed: Apr. 8, 2025

(51) Int. Cl. G06F 16/215; G06F 16/23

(52) U.S. Cl. CPC G06F 16/215; G06F 16/2365

(57) ABSTRACT

Systems and methods described herein relate to identifying and cleaning up data objects in database systems. A system accesses one or more databases to retrieve metadata for a plurality of data objects. For each data object, the system processes the metadata to detect that production usage satisfies at least one first condition and that modification history satisfies at least one second condition. After detecting that these conditions are satisfied, the system computes a risk classification for the data object from among a plurality of supported risk classifications. The system then automatically triggers a deletion process for the plurality of data objects based on the risk classification.

### TECHNICAL FIELD

The subject matter disclosed herein generally relates to database technology. Particularly, but not exclusively, the subject matter relates to systems and methods for implementing database cleanup methodologies.

### BACKGROUND

Software systems can accumulate a significant number of obsolete or unwanted data objects, such as unused database tables or unused source code objects. For example, large-scale enterprise applications can contain thousands of database tables or millions of lines of code that remain in systems after their useful life has ended.

### BRIEF DESCRIPTION OF THE DRAWINGS

Some examples are shown for purposes of illustration and not limitation in the figures of the accompanying drawings. In the drawings, which are not necessarily drawn to scale, like numerals may describe similar components in different views or examples. To identify the discussion of any particular element or act more easily, the most significant digit or digits in a reference number refer to the figure number in which that element is first introduced.

FIG. 1 is a diagrammatic representation of a network environment that includes a data cleanup system, according to some examples.

FIG. 2 is a block diagram illustrating components of a data cleanup system, according to some examples.

FIG. 3 is a flowchart illustrating a method for detecting data cleanup targets and triggering data cleanup actions, according to some examples.

FIG. 4 is a flowchart illustrating a method for detecting data cleanup targets and triggering data cleanup actions, according to some examples.

FIG. 5 is a flowchart illustrating a method for generating a risk classification and triggering cleanup actions based on the risk classification, according to some examples.

FIG. 6 is a flowchart illustrating a method for detecting data cleanup targets and triggering data cleanup actions, according to some examples.

FIG. 7 is a block diagram of a computing system, according to some examples, within which instructions may be executed to perform one or more of the methodologies discussed herein.

### DETAILED DESCRIPTION

Storage needs associated with obsolete data objects can continuously increase as systems grow (e.g., unused code or tables consume memory or storage resources), development complexity rises as developers navigate redundant data objects, and security vulnerabilities may persist in relation to rarely used objects (e.g., even unused code is typically subject to security fixes).

The handling of such legacy data objects can create significant technical challenges. On the one hand, a system that applies overly conservative cleanup methodologies allows unnecessary bloat to persist, which may fail to adequately address technical challenges or risks. On the other hand, incorrect targeting of data objects for deletion can potentially disrupt system functionality or lead to the loss of valuable data.

Automating a data cleanup process in large, complex systems introduces risks such as accidental data loss or disruption of application features, and thus demands careful design. First, determining what qualifies as a target for cleanup is technically challenging and simple retention policies do not necessarily cover all desired targets. Outdated data objects may be of various types, ranging from low risk (e.g., easy to recreate with minimal system disruption if active data is lost) to high risk (e.g., hard to recreate or serious system disruptions caused if active data is lost). Moreover, data objects that appear to be old or unused can have dependencies-such as relationships with active data objects—that can complicate or prevent safe deletion without breaking data integrity or application logic.

The subject matter described herein relates to systems and methods for identifying and removing data objects, such as unused database tables or unused source code, from database systems. In some examples, an automated, structural technical solution is provided for effectively identifying and managing data cleanup targets or cleanup candidates.

An example system accesses one or more databases to retrieve metadata for a plurality of data objects. For each data object, the system may process at least the metadata related to that data object to obtain information related to aspects such as production usage and modification history of the data object. Based on results obtained by the system, the system generates a risk classification for the data object which can be applied to determine a data cleanup action for the data object.

A “data object,” as used herein, can include a structured or unstructured object, element, or set of elements within a database or other storage system that stores, organizes, or represents information, or defines or otherwise enables functionality. Examples of data objects include database tables, source code objects, metadata structures, or configuration settings. Source code objects may include programmatic elements or sets of elements associated with a software system, such as classes, methods, function modules, packages, Application Programming Interfaces (APIs), or other code components or sets of components. Data objects may be characterized by various metadata such as creation date, modification history, usage patterns, reference relationships with other objects, object type, or object function.

A “risk classification,” as used herein, can include a classification, categorization, ranking or label assigned to data objects based on multiple dimensions of analysis to determine an appropriate cleanup action. In some examples, a risk classification provides an indication of the level of perceived or potential risk associated with deleting a data object. In some examples, risk classifications include low risk, medium risk, and high-risk categories, with each category triggering different system actions. However, various types of risk classifications may be employed in other examples.

In some implementations, a risk classification is automatically computed for a data object by checking an object type of the data object. In some cases, the risk classification may be determined by applying a preconfigured risk model (e.g., a risk matrix).

The example system can be configured to check whether the production usage of the data object satisfies at least one first condition and whether the modification history of the data object satisfies at least one second condition. For example, if the system detects that the first condition and the second condition are satisfied, the system computes a specific risk classification for the data object, selected from among a plurality of risk classifications supported by the system. The system may then automatically trigger a deletion process based on the risk classification.

In some examples, the system thus triggers a data cleanup action in the form of a deletion process. A “deletion process,” as used herein, can include operations to remove obsolete data objects from a system automatically (e.g., through a soft purge or hard purge). A deletion process can, alternatively or additionally, include operations to flag or mark data objects for quarantine or monitoring (e.g., for possible future deletion). The deletion process may involve one or multiple computing operations, such as automated cleanup or flagging a data object for further review and then performing such further review. In some examples, the deletion process may include different workflows based on the risk classification of the data objects.

The plurality of data objects may comprise a plurality of database tables, with processing of metadata being performed for each database table of the plurality of database tables. For instance, for a database table, a first condition (e.g., usage-related condition) may include that usage of the database table by source code objects in production is at or below a predetermined threshold (which may be set at zero). Second conditions (e.g., object history-related conditions) may include that a record count of the database table is at or below a further predetermined threshold (which may be set at zero), that the database table has not been created or modified within a predetermined time period, or a combination thereof.

In some examples, the plurality of data objects comprises a plurality of source code objects, with processing of the metadata being performed for each source code object of the plurality of source code objects. For source code objects, first conditions (e.g., usage-related conditions) may include that usage of the source code object in production within a predetermined time period is at or below a first threshold, that dependent source code objects associated with the source code object are at or below a second threshold (which may be set at zero), or a combination thereof. A second condition (e.g., object history-related conditions) may comprise that the source code object has not been created or modified within a predetermined time period.

The example system may automatically prioritize certain data objects for cleanup. For example, the system processes the metadata of data objects to identify respective object sizes, computes a prioritization based on the respective sizes, and performs the deletion process based on the prioritization (e.g., deletes larger data objects or larger batches of data objects first).

Systems and methods in the present disclosure may address technical problems through a multi-dimensional analysis approach. In some examples, the system performs multiple parallel computing operations to determine a suitable cleanup action for a particular data object or batch of data objects. The multi-dimensional analysis that considers, for example, one or more of usage, dependencies, and object history can reduce the risk that an unsuitable or incorrect data object is removed from a storage system, while allowing for a useful reduction in storage space requirements. For example, in enterprise systems such as Enterprise Resource Planning (ERP) systems leveraging vast datasets, the system can potentially identify thousands of database tables or thousands of source code objects as candidates for removal, allowing for significant reductions in database size. This can, in turn, lead to improved query performance, reduced memory consumption, and lower infrastructure costs.

This approach may thus allow a computing system to reclaim storage or memory resources efficiently, facilitate system maintenance, or reduce storage costs, particularly in cloud environments where resources directly impact operational expenses. A system of the present disclosure may further support flagging objects as deprecated with alerts to user computing devices, allowing teams to be notified about potential risks or expected actions.

By limiting the presence of unused, rarely used, or unmaintained data objects, a system as described herein can reduce an attack surface for security vulnerabilities in storage systems (e.g., an attack surface for injecting problematic data into existing source code). Moreover, by implementing methodologies described herein, computing resources can be more effectively focused on relevant and maintained data objects rather than spending computing resources on unnecessary data objects.

Further technical benefits can be obtained, in at least some examples, through risk-based classification or prioritization that accounts for factors such as object type, size, usage, or dependencies. Furthermore, the introduction of monitoring processes or escalation mechanisms may allow for more consistent and disciplined cleanup processes.

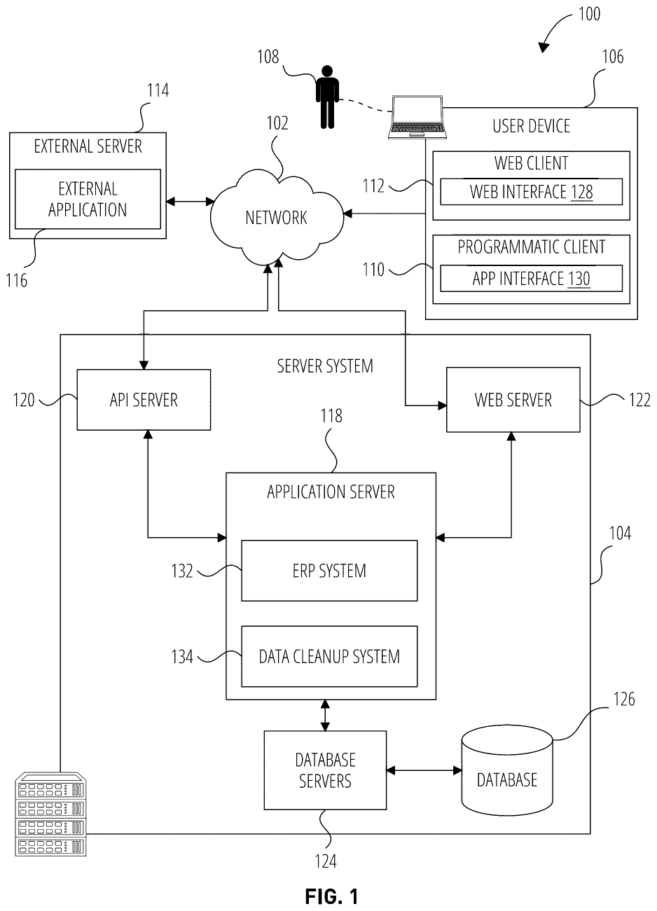

FIG. 1 is a diagrammatic representation of a networked computing environment 100 in which some examples of the present disclosure may be implemented or deployed. One or more servers in a server system 104 provide server-side functionality via a network 102 to a networked device, in the example form of a user device 106 that is accessed by a user 108. A web client 112 (e.g., a browser) or a programmatic client 110 (e.g., an “app”) may be hosted and executed on the user device 106.

An Application Program Interface (API) server 120 and a web server 122 provide respective programmatic and web interfaces to components of the server system 104. An application server 118 hosts an ERP system 132 and a data cleanup system 134, which can include components, modules, or applications.

The user device 106 can communicate with the application server 118 via the web interface supported by the web server 122 or via the programmatic interface provided by the API server 120. It will be appreciated that, although only a single user device 106 is shown in FIG. 1, a plurality of user devices may be communicatively coupled to the server system 104 in some examples. Further, while certain functions may be described herein as being performed at either the user device 106 (e.g., web client 112 or programmatic client 110) or the server system 104, the location of certain functionality either within the user device 106 or the server system 104 may be a design choice.

The application server 118 is communicatively coupled to database servers 124, facilitating access to one or more information storage repositories, such as a database 126. In some examples, the database 126 includes storage devices that store information to be processed by the ERP system 132 and the data cleanup system 134, such as data objects processed as part of a data cleanup pipeline.

The application server 118 accesses application data (e.g., application data stored by the database servers 124) to provide one or more applications, features, or software tools to the user device 106 via a web interface 128 or an app interface 130. Such applications, features, or tools can include the ERP system 132 or the data cleanup system 134.

The ERP system 132 provides an integrated software platform that centralizes and automates business processes such as finance, supply chain, manufacturing, and human resources. The ERP system 132 may provide real-time data visibility and operational efficiency across departments, seeking to enable better decision-making and streamlined workflows. The ERP system 132 represents one example of a system with which the data cleanup system 134 may be used. The ERP system 132 may leverage numerous data objects, such as database tables and source code objects, that have accumulated over time, at least some of which are potentially unused.

The data cleanup system 134 provides a comprehensive software framework for identifying and removing data objects from storage systems, such as from the database 126. The data cleanup system 134 may interact with the ERP system 132 or with data objects associated with the ERP system 132 to analyze and manage data cleanups.

In some examples, the data cleanup system 134 automatically analyzes database tables for potential deletion. For example, the ERP system 132 stores various types of information in tables that are labeled according to an object type, such as a delivery class. Examples of delivery classes include “temporary data,” “system data,” “customizing data,” and “application data.”

Alternatively, or additionally, the data cleanup system 134 automatically analyzes source code for potential deletion. For example, the ERP system 132 can have a repository with information related to source code of one or more of its applications. Source code objects may be cloud-based or delivered by a software vendor in on-premises deployments. Much like tables, source code objects may accumulate over time and may benefit from cleanup operations.

While the data cleanup system 134 is shown together with the ERP system 132 in FIG. 1, the data cleanup system 134 can alternatively or additionally be used with respect to data objects of various other types of systems. For example, a multi-dimensional detection approach for identifying unused data objects employed by the data cleanup system 134 may be applied to various types of database systems beyond ERP systems, such as customer relationship management (CRM) systems, media content management systems, or general data warehouses.

In some examples, the application server 118 is part of a cloud-based platform provided by a software provider that allows the user 108 to utilize features of the ERP system 132 or features of the data cleanup system 134. For example, an account holder may access one or more cloud instances to communicate with the ERP system 132 to manage or control business operations or to communicate with the data cleanup system 134 to set data cleanup parameters or preferences.

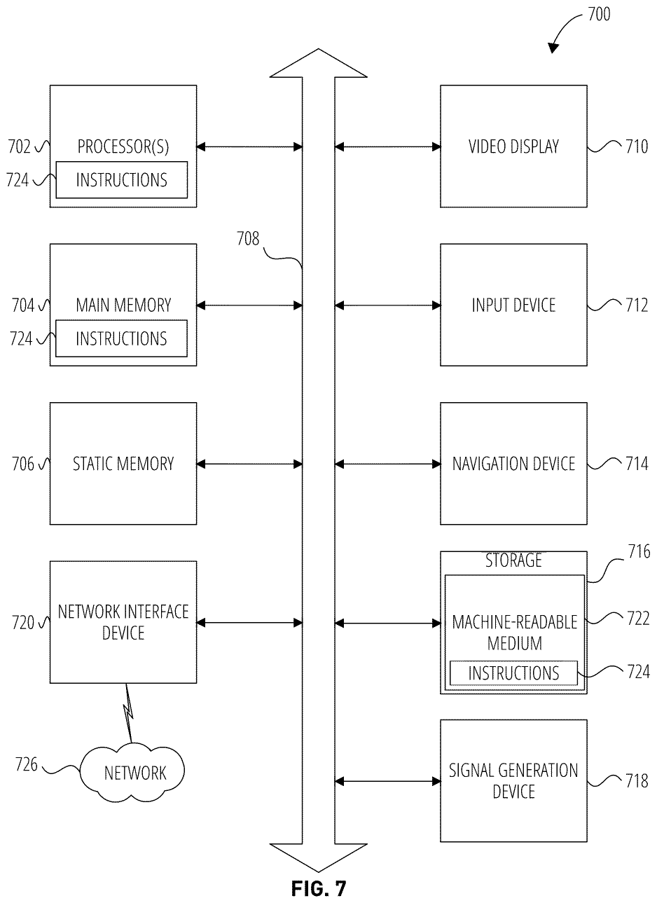

One or more of the application server 118, the database servers 124, the API server 120, or the web server 122 may each be implemented in a computer system, in whole or in part. This can include, for example, a computing environment as described below with respect to FIG. 7. In some examples, external applications, such as an external application 116 executing on an external server 114, can communicate with the application server 118 via the programmatic interface provided by the API server 120. For example, a third-party application may support one or more features or functions on a website or platform hosted by a third party, or may perform certain methodologies and provide input or output information to the application server 118 for further processing or publication.

The network 102 may be any network that enables communication between or among machines, databases, and devices. Accordingly, the network 102 may be a wired network, a wireless network (e.g., a mobile or cellular network), or any suitable combination thereof. The network 102 may include one or more portions that constitute a private network, a public network (e.g., the Internet), or any suitable combination thereof.

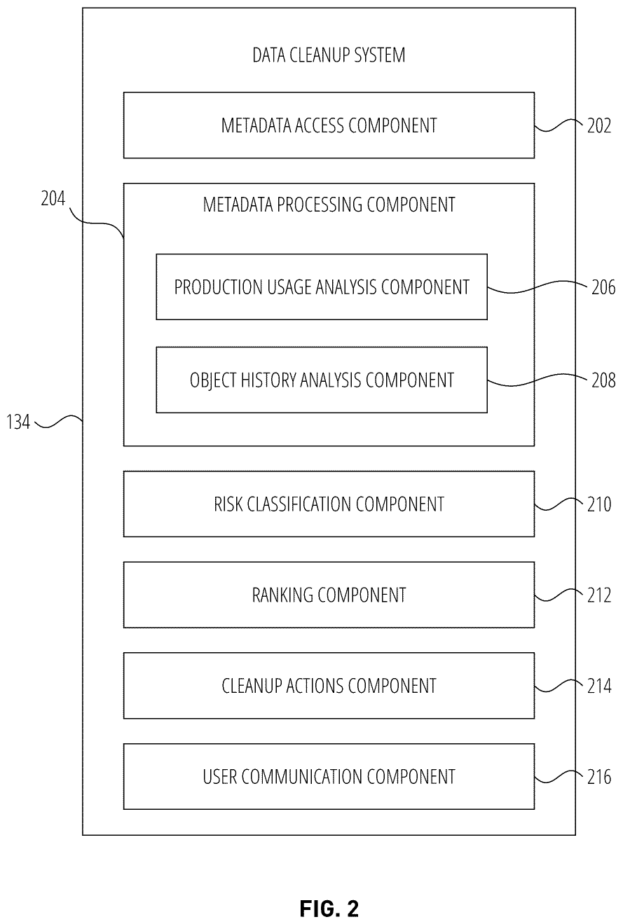

FIG. 2 illustrates components of the data cleanup system 134 of FIG. 1, according to some examples. The data cleanup system 134 is shown to include a metadata access component 202, a metadata processing component 204, a risk classification component 210, a ranking component 212, a cleanup actions component 214, and a user communication component 216.

In some examples, at least some of the components shown in FIG. 2 are configured to communicate with each other to implement aspects described herein. One or more of the components described herein may be implemented using hardware (e.g., one or more processors of one or more machines) or a combination of hardware and software. For example, a component described herein may be implemented by a processor configured to perform the operations described herein for that component. Moreover, two or more of these components may be combined into a single component, or the functions described herein for a single component may be subdivided among multiple components. Furthermore, according to various examples, components described herein may be implemented using a single machine, database, or device, or be distributed across multiple machines, databases, or devices.

Referring firstly to the metadata access component 202 of the data cleanup system 134, the metadata access component 202 is configured to access one or more storage systems (e.g., databases) to provide access to or retrieve metadata for data objects being assessed by the data cleanup system 134. For example, the metadata access component 202 automatically queries system tables to gather information about database tables associated with the ERP system 132, including their aspects such as creation dates, modification history, dependencies, or usage patterns, or enables other components of the data cleanup system 134 to perform such queries. As another example, the metadata access component 202 automatically extracts information about source code objects from a central source code repository table associated with the ERP system 132.

The metadata processing component 204 processes the metadata obtained by the metadata access component 202 and coordinates the analysis thereof. In some examples, the metadata access component 202 and the metadata processing component 204 work together to implement complex, automated queries (e.g., Structured Query Language (SQL)) in relational database systems to identify or categorize potential cleanup targets.

In FIG. 2, the metadata processing component 204 is shown to include both a production usage analysis component 206 and an object history analysis component 208. The production usage analysis component 206 of the metadata processing component 204 is designed to check whether, or the manner in which, data objects are being used in production environments. In some examples, the production usage analysis component 206 also checks relationships or dependencies between data objects, since this may be indicative of production usage or indicate a higher risk of production usage.

For database tables, the production usage analysis component 206 may verify if a table is referenced by any active source code. For source code objects, the production usage analysis component 206 may analyze call monitor data from production systems to determine if the code has been executed within a configurable time period, such as one year, two years, or three years.

The production usage analysis component 206 can also analyze dependencies of source code objects. In some examples, the production usage analysis component 206 detects both static and dynamic usage patterns to minimize the risk of removing objects that are still in use.

The object history analysis component 208 is configured to check object history or object status, such as when a data object was created, when the data object was modified, and which content items or attributes it has. For example, the object history analysis component 208 checks whether objects have been updated within a configurable timeframe, such as three years, five years, or ten years. For source code objects, the object history analysis component 208 may check the last modification date in a repository. The object history analysis component 208 may flag objects with no updates in an extended period of time (e.g., three years, five years, or ten years) as potentially obsolete.

In some examples, the object history analysis component 208 also analyzes object history or status from an object contents perspective. For example, the object history analysis component 208 analyzes current contents of data objects, or whether items or content have been added to or removed from data objects. For database tables, the object history analysis component 208 may analyze the record count to determine if the table is empty or the record count is below a threshold. Object history data may thus indicate that a data object has never been populated or has been empty for an extended period of time.

The risk classification component 210 may compute a risk classification for each data object, or for batches of similar data objects, based on the results from the metadata processing component 204, specific object metadata, or combinations thereof. In some examples, the risk classification component 210 determines an object type of a data object and automatically selects an appropriate risk classification from among supported classifications. In some examples, the risk classification component 210 categorizes objects as low, medium, or high risk (or using some other risk rating system, such as numbers one to ten) based on factors such as delivery class for database tables or dependency relationships for source code objects.

In some examples, the risk classification component 210 applies a preconfigured risk model to generate a risk classification. The risk model may include a preset framework that defines a plurality of supported risk classifications based on one or multiple dimensions of analysis. The risk model may be loaded by the risk classification component 210 and automatically applied to obtain the risk classification for data objects.

In some examples, a risk model incorporates rules for evaluating both production usage conditions and object history conditions, such as whether a source code object has been used in production within a predetermined time period and whether it has been modified within another predetermined time period. The risk model may be in the form of a stored risk matrix. The risk model may be continuously refined based on feedback from previous cleanup operations, potentially allowing the data cleanup system 134 to improve its accuracy in identifying truly obsolete objects while reducing the risk of removing objects that might still be needed.

The risk classification component 210 may implement one or more trained machine learning models to generate a risk classification. A machine learning model (e.g., a neural network) can be trained on historical data from previous cleanup operations to identify patterns that indicate obsolescence risk. Such a model can analyze complex relationships between factors such as usage metrics, object dependencies, or object history to predict which objects are safe to remove with high confidence. Additionally, a model can continuously improve through feedback loops that incorporate the outcomes of previous cleanup decisions, allowing the data cleanup system 134 to adaptively refine its classification accuracy over time.

The ranking component 212 is designed to rank or prioritize data objects for cleanup based on one or various factors. The ranking component 212 may process metadata to identify respective sizes of data objects and compute a prioritization based on these sizes. In some examples, the ranking component 212 may implement an “ABC analysis” approach that targets the largest unused objects first to seek to maximize resource reclamation with minimal effort. The ranking component 212 may also consider factors such as age, usage patterns, and risk classification when determining a cleanup order.

The cleanup actions component 214 triggers appropriate system actions within the data cleanup system 134 and linked storage systems. In some examples, the cleanup actions component 214 triggers a deletion process based at least partially on the relevant data object's risk classification. For example, for low-risk objects, the cleanup actions component 214 initiates automated deletion, while for medium-risk objects, it triggers a review process, and for high-risk objects, it automatically places the objects in quarantine within the data cleanup system 134 or an associated database for observation (e.g., over a release cycle associated with the production environment).

The cleanup actions component 214 can perform data deletions such as hard or soft purges. The cleanup actions component 214 may automatically modify stored data structures to delete objects or update databases to flag objects as deprecated.

The user communication component 216 generates notifications or reports about the cleanup process. For example, the user communication component 216 generates alerts to user computing devices (e.g., to the user device 106 of FIG. 1) indicating which objects have been flagged as deprecated, scheduled for deletion, or already deleted through an automated process. In some examples, the user communication component 216 generates error messages to enforce mandatory cleanup by developers for objects identified as cleanup targets. The user communication component 216 may also provide statistics about aspects such as storage savings and other technical benefits achieved through a cleanup process.

In some examples, a user (e.g., the user 108 of FIG. 1) can provide input via the user communication component 216. For example, the user 108 can select databases for the data cleanup system 134 to analyze periodically, adjust parameters or settings (e.g., threshold for the metadata processing component 204 to apply), or indicate reporting preferences.

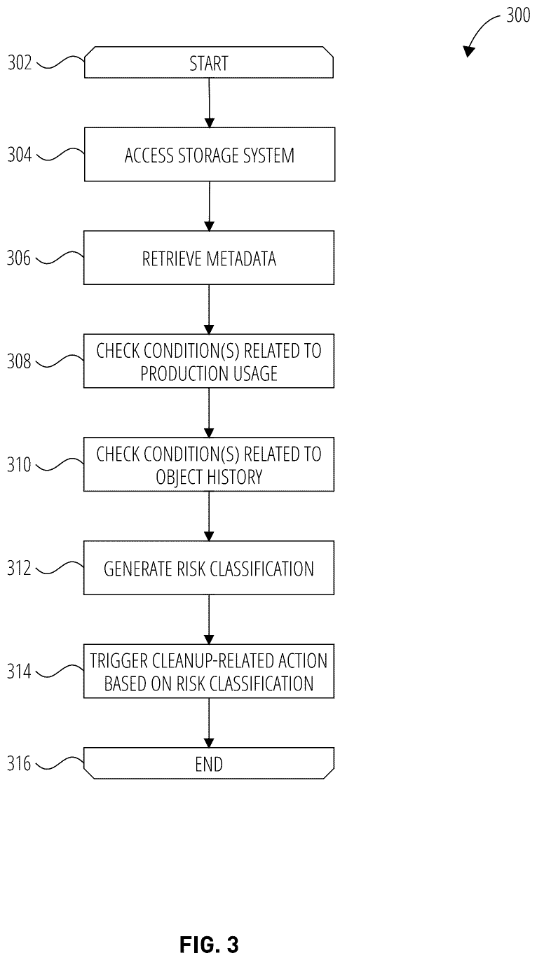

FIG. 3 illustrates a method 300 for detecting data cleanup targets and triggering data cleanup actions, according to some examples. The method 300 may be performed by a computing system such as the data cleanup system 134 of FIG. 1 and FIG. 2. Accordingly, to illustrate certain aspects of the method 300, reference is made to the data cleanup system 134 in the description that follows.

The method 300 commences at opening loop operation 302, where the data cleanup system 134 initiates an analysis process. This process may be started by the data cleanup system 134 based on various triggers, such as according to a scheduled maintenance routine, a manual request, or in response to system resource monitoring thresholds being reached.

Typically, the method 300 is performed substantially simultaneously with respect to a large number of data objects (e.g., hundreds, thousands, or hundreds of thousands) to identify data objects that can be removed from a storage system or for which some other cleanup action is appropriate. Accordingly, while certain aspects of operation 304 through operation 314 are described for a single data object, this description is provided for illustrative purposes, and it should be appreciated that similar operations can be performed by the data cleanup system 134 across a large number of data objects.

At operation 304, the data cleanup system 134 accesses a storage system (e.g., one or more databases, such as the database 126 of FIG. 1) to allow for retrieval of information about data objects. For example, operation 304 establishes the foundation for subsequent analysis by creating connections to the relevant data source or sources.

At operation 306, the metadata access component 202 retrieves metadata for a data object. For database tables, this metadata can include, for example, creation dates, modification timestamps, record counts, and usage references. For source code objects, the metadata can include, for example, last modification dates, call histories, execution statistics, and reference information.

The method 300 proceeds to operation 308, where the production usage analysis component 206 processes the metadata to check one or more conditions related to production usage of the data object. For example, the production usage analysis component 206 checks whether one or more of the following conditions are met: whether a data object is referenced by source code, whether a data object has active dependencies, and whether the data object has been executed or otherwise used in a production environment (e.g., of the ERP system 132) within a predefined period (or whether usage is below a threshold). The production usage analysis component 206 records the results of these conditional checks.

At operation 310, the object history analysis component 208 processes the metadata to check one or more conditions related to object history or status. For example, the object history analysis component 208 checks whether one or more of the following conditions are met: whether a data object (e.g., a table) is empty, whether a data object was created within a certain period, or whether the data object was modified within a certain period. The object history analysis component 208 records the results of these conditional checks.

At operation 312, the risk classification component 210 of the data cleanup system 134 generates a risk classification for the data object based on the results from the previous operations. The risk classification component 210 may determine an object type and may automatically select an appropriate risk classification from among supported classifications (e.g., low, medium, or high risk) based on the object type and the outcome of the conditional checks. In some examples, the risk classification component 210 applies a risk model to the data object to generate, based on the results of the conditional checks, an appropriate risk classification.

The method 300 proceeds to operation 314, where the cleanup actions component 214 triggers a cleanup-related action based on at least the risk classification for the data object. For example, the cleanup actions component 214 triggers a deletion process. The deletion process may include updating one or more databases by automatically deleting or purging the data object, to flag the data object as deprecated before actual removal, or transmitting an alert to a user computing device indicating that the object has been flagged. In some examples, the operation 314 involves the cleanup actions component 214 raising an error message in a user interface or application to enforce mandatory cleanup by data object owners or developers. The deletion process may also incorporate prioritization, for example, based on object size, with larger objects being targeted first to improve resource reclamation.

The method 300 concludes at closing loop operation 316. At one or various stages of the method 300, the user communication component 216 of the data cleanup system 134 may generate notifications about detections or actions taken and update relevant system logs. In some examples, the data cleanup system 134 can update a watchlist for data objects to be further monitored before a final decision can be made.

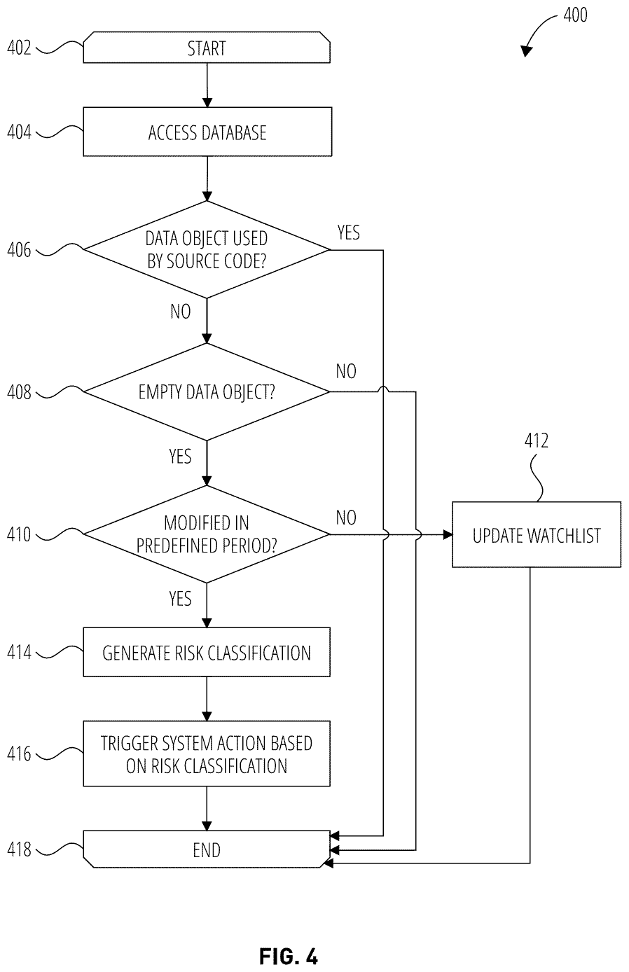

FIG. 4 illustrates a method 400 for detecting data cleanup targets and triggering data cleanup actions, according to some examples. The method 400 may be performed by a computing system such as the data cleanup system 134 of FIG. 1 and FIG. 2. Accordingly, to illustrate certain aspects of the method 400, reference is made to the data cleanup system 134 in the description that follows.

In the method 400 of FIG. 4, the data objects analyzed by the data cleanup system 134 are database tables (e.g., legacy tables targeted to free up storage space). For example, the data cleanup system 134 analyzes tables associated with the ERP system 132. At least some of the operations of the method 400 may, however, also be performed with respect to other types of data objects.

The method 400 commences at opening loop operation 402, where the data cleanup system 134 initiates an analysis process. This process may be started by the data cleanup system 134 based on various triggers, such as according to a scheduled maintenance routine, a manual request, or in response to system resource monitoring thresholds being reached.

Typically, the method 400 is performed substantially simultaneously with respect to a large number of tables to identify a set of deletion candidates or targets. Accordingly, while certain aspects are described for a single table, this description is provided for illustrative purposes, and it should be appreciated that similar operations can be performed by the data cleanup system 134 across a large number of tables.

At operation 404, the data cleanup system 134 accesses a storage system (e.g., one or more databases, such as the database 126 of FIG. 1) to allow for retrieval of information about tables. The metadata access component 202 can operate to provide such access. The data cleanup system 134 then commences with processing of table metadata. In the example of FIG. 4, the data cleanup system 134 is configured to perform an automated, multi-dimensional analysis to detect tables that may be unnecessarily stored due to such tables being: (a) not referenced in source code, (b) empty, and (c) not modified within a predefined period.

To perform this multi-dimensional analysis, the data cleanup system 134 (e.g., the metadata processing component 204) can access and analyze various data structures. For example, the data cleanup system 134 queries a data dictionary table that provides a list of tables associated with the ERP system 132. This table may provide details such as “last modification date.” The data cleanup system 134 further queries a usage analysis table that is generated and continuously updated for the ERP system 132 to reference tables used in source code. If a table is not referenced in the usage analysis table, it is not used (at least from a static perspective). The data cleanup system 134 can further query a database information system view that lists all the tables and an indication of their contents (e.g., record counts).

In the method 400 of FIG. 4, the data cleanup system 134 operates as follows to determine whether a particular table is a potential target or candidate. The data cleanup system 134 checks, at decision operation 406, whether the table is used by source code. If the result is “yes,” the table is not flagged as a candidate and the method 400 simply concludes at closing loop operation 418 for the relevant table. If the result is “no,” the method 400 proceeds to decision operation 408.

At decision operation 408, the data cleanup system 134 checks whether the table is empty. If the result is “no,” the table is not flagged as a candidate and the method 400 concludes for the relevant table. In other words, if the table has records or entries therein, the table is not flagged as a candidate. If the result is “yes,” the method 400 proceeds to decision operation 410. In other examples, the data cleanup system 134 may also return “yes” if the table contains records but the total number of records is fewer than a predetermined threshold.

At decision operation 410, the data cleanup system 134 checks whether the table has been modified within a predefined period, such as within the past five years. If the result is “no,” the table is not flagged as a candidate but a watchlist data structure (e.g., in the database 126) is updated, at operation 412, to trigger further monitoring of the table before the method 400 concludes at closing loop operation 418. This watchlist may be used for monitoring objects that partially meet the deletion criteria but require further observation before a final decision can be made. If the result is “yes,” the table is flagged as a candidate. For example, it might be premature to delete a table that is empty and not used by source code, but that was relatively recently created or modified, so the data cleanup system 134 performs operation 412.

Thus, if a table satisfies each of three conditions or criteria, the data cleanup system 134 regards it as a candidate for cleanup. It is noted that the data cleanup system 134 typically checks these conditions for a large number of tables simultaneously to identify a subset of them as candidates.

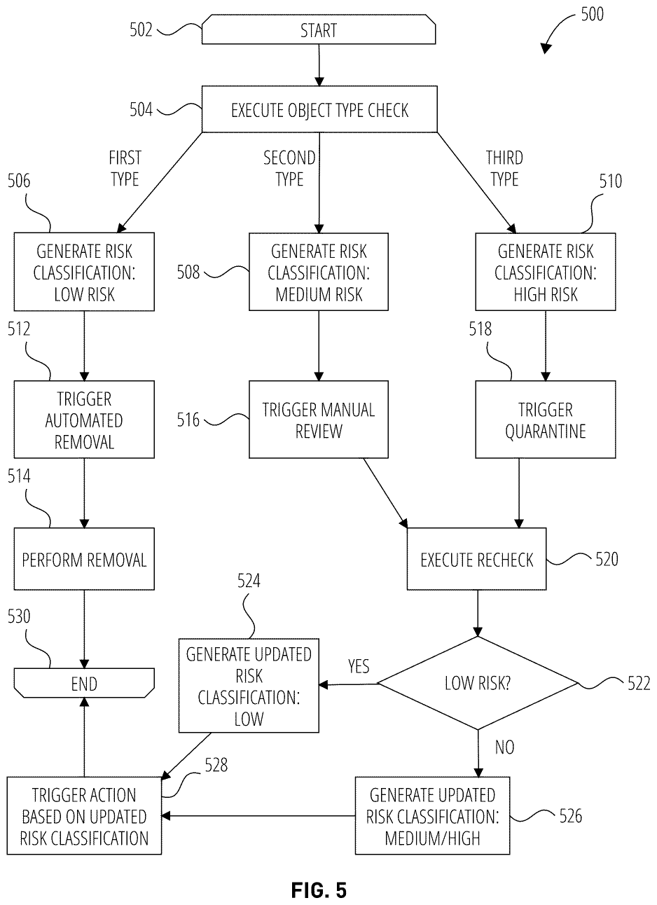

The method 400 proceeds to operation 414, where the data cleanup system 134 computes a risk classification for the table (e.g., using the risk classification component 210). For example, the data cleanup system 134 checks an object type of the table and determines a risk level associated with that object type according to a predefined mapping stored in the database 126. Examples of risk classification approaches are described in more detail with reference to FIG. 5.

At operation 416, the data cleanup system 134 triggers system action based on the risk classification. For example, for low-risk data objects, this may involve automated deletion performed by the cleanup actions component 214. For medium-risk objects, the data cleanup system 134 may trigger review processes. For high-risk objects, the data cleanup system 134 may place them in quarantine for observation over a release cycle. The closing loop operation 418 concludes at closing loop operation 418.

Merely as an example, the following “SELECT” (SQL) statement may be automatically performed by the data cleanup system 134 to identify, from thousands of database tables, a set of candidate tables that have no references in source code (usage_count=0), are empty (record_count=0), and have not been modified since a certain date (e.g., not modified since 2020). The data cleanup system 134 may thus efficiently combine multiple conditional checks for multiple data objects into integrated queries or other programmatic operations.

```
SELECT *
FROM
  (SELECT datadictionary.tabname,
          datadictionary.modification_date,
          count(usageanalysis.tabname) AS usage_count
    FROM datadictionary
    LEFT JOIN usageanalysis ON datadictionary.tabname =
usageanalysis.tabname
    WHERE tabclass = ‘TRANSP’
      AND local_indicator = ‘A’
      AND version_number = ‘0000’
    GROUP BY datadictionary.tabname,
            datadictionary.modification_date
    ORDER BY usage_count,
            tabname) AS outertab
INNER JOIN databaseinfo_tables ON outertab.tabname =
databaseinfo_tables.table_name
WHERE usage_count = 0
  AND record_count = 0
  AND (modification_date like ‘19%’
        OR modification_date like ‘200%’
        OR modification_date like ‘201%’)
```

FIG. 5 is a flowchart illustrating a method 500 for generating a risk classification and triggering cleanup actions based on the risk classification, according to some examples. The method 500 may be performed by a computing system such as the data cleanup system 134 of FIG. 1 and FIG. 2. Accordingly, to illustrate certain aspects of the method 500, reference is made to the data cleanup system 134 in the description that follows. At least some parts of the method 500 may be utilized in the method 300 of FIG. 3 (e.g., in operation 312 and operation 314) or in the method 400 of FIG. 4 (e.g., in operation 414 and operation 416).

The method 500 commences at opening loop operation 502, where the data cleanup system 134 accesses a data object that has been identified as a candidate or target for cleanup operations. For example, the data object is a table, and the data cleanup system 134 has identified that the table is not referenced in source code, is empty, and has not been modified in the past five years (merely as an example). The data cleanup system 134 starts a process of classifying the data object based on risk associated with its deletion.

The data cleanup system 134 executes an object type check at operation 504. For example, the data cleanup system 134 checks metadata to identify a delivery class of a table. Based on the object type, the data cleanup system 134 generates a risk classification, which can classify the data object as low risk (operation 506), medium risk (operation 508), or high risk (operation 510).

For example, if a table has object type “temporary data” or “standard system data,” the data cleanup system 134 assigns a low risk to its deletion, while if the table has object type “customer data” or “application data,” the data cleanup system 134 assigns a higher risk thereto. Temporary data tables or standard system data tables may be considered to have minimal risk for deletion since they either contain temporary data or standard system data that can be easily recreated if needed. On the other hand, the consequences of incorrectly deleting customer data or application data may be more severe. In some examples, the data cleanup system 134 assesses multiple data objects and generates different risk classifications for different data objects based on respective object types.

If the data object is classified as low risk, the method 500 proceeds to operation 512 where the data cleanup system 134 triggers automated removal of the data object (e.g., as part of a batch of data objects that are all classified as low risk). The data cleanup system 134 then executes the removal (e.g., purging operations) at operation 514 and the method 500 concludes at closing loop block 530.

For a data object that is classified as medium risk, the method 500 proceeds to operation 516. This classification indicates that additional verification is recommended before deletion and the data cleanup system 134 triggers manual review. For example, the user communication component 216 of the data cleanup system 134 sends an alert to the user 108, prompting the user to verify that the table can be safely deleted, providing an additional safeguard for tables with moderate deletion risk. The method 500 then proceeds to operation 520, which is described further below.

If a data object is classified as high risk, the method 500 proceeds to operation 518 where the data cleanup system 134 triggers quarantine of the data object. For example, in the case of the ERP system 132, a high-risk table remains in the ERP system 132 but is flagged as deprecated and may be restricted from further use (or its use may be limited) while being monitored by the data cleanup system 134 for unexpected impacts.

At operation 520, the data cleanup system 134 executes a recheck. For example, after a table was manually confirmed to be unused, the data cleanup system 134 checks the user input provided as the basis for reassessing the deletion risk for the relevant object. As another example, if a table was quarantined, the data cleanup system 134 checks the metadata of the table again (e.g., performs the conditional checks described with reference to FIG. 4) after the quarantine period is over (e.g., after 6 months, after 1 year, or after a release cycle). At decision operation 522, the data cleanup system 134 determines whether the rechecked data object now presents a low risk for deletion.

The data cleanup system 134 then generates an updated risk classification, which in the case of FIG. 5 can be either low risk (operation 524) or medium/high risk (operation 526). At operation 528, the data cleanup system 134 triggers action based on the updated risk classification. For example, if the data object now presents low risk, the data cleanup system 134 can perform operations similar to operation 512 and operation 514. On the other hand, if the data object still presents a risk that is higher than “low,” the data cleanup system 134 may trigger alternative actions instead of automated removal. This may include extending the quarantine period as part of an ongoing or pending deletion process, scheduling another review, or implementing other risk mitigation measures. The method 500 concludes at closing loop block 530. The user communication component 216 may update relevant system logs and generate notifications about the actions taken.

As mentioned, the data cleanup system 134 can generate different risk classifications for different batches of data objects. For example, for a first batch of data objects identified as deletion candidates (e.g., through operations of FIG. 4) with a risk classification of “low risk,” the data cleanup system 134 automatically deletes the first batch, while for a second batch of data objects identified as deletion candidates with a risk classification of “high risk,” the data cleanup system 134 flags them (e.g., for quarantine) as part of a pending deletion process instead of immediately or automatically removing them.

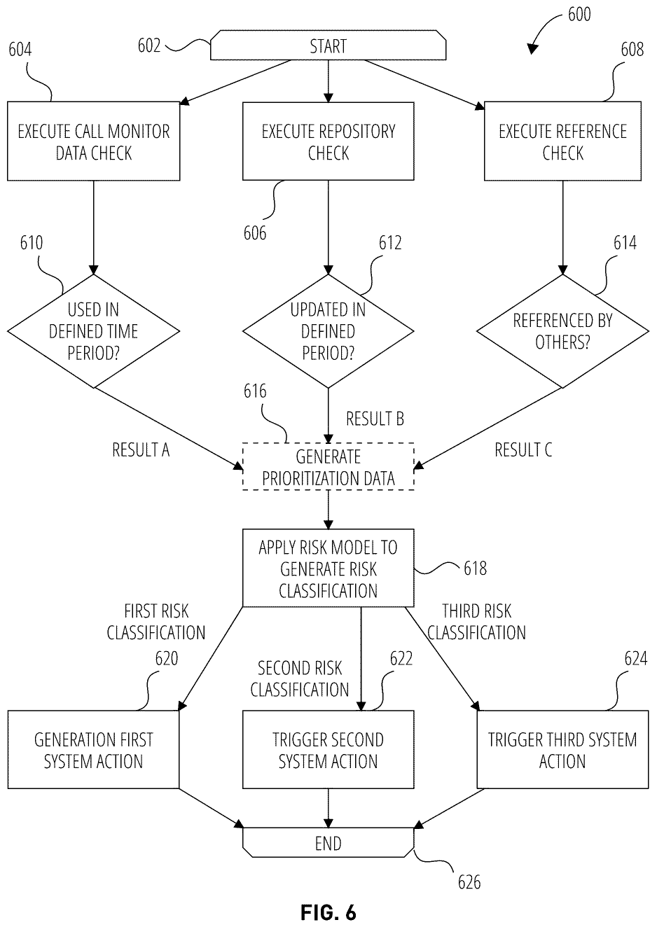

FIG. 6 is a flowchart illustrating a method 600 for detecting data cleanup targets and triggering data cleanup actions, according to some examples. The method 600 may be performed by a computing system such as the data cleanup system 134 of FIG. 1 and FIG. 2. Accordingly, to illustrate certain aspects of the method 600, reference is made to the data cleanup system 134 in the description that follows.

In the method 600 of FIG. 6, the data objects analyzed by the data cleanup system 134 are source code objects (e.g., legacy code targeted to free up storage space). For example, the data cleanup system 134 analyzes source code associated with the ERP system 132. At least some of the operations of the method 600 may, however, also be performed with respect to other types of data objects.

The method 600 commences at opening loop operation 602, where the data cleanup system 134 initiates an analysis process. This process may be started by the data cleanup system 134 based on various triggers, such as according to a scheduled maintenance routine, a manual request, or in response to system resource monitoring thresholds being reached.

Typically, the method 600 is performed substantially simultaneously with respect to a large number of source code objects to identify a set of deletion candidates or targets. Accordingly, while certain aspects are described for a single source code object, this description is provided for illustrative purposes, and it should be appreciated that similar operations can be performed by the data cleanup system 134 across a large number of source code objects (e.g., thousands or even millions of lines of code).

To start the process, the data cleanup system 134 accesses a storage system (e.g., one or more databases, such as the database 126 of FIG. 1) to allow for retrieval of information about source code objects. The metadata access component 202 can operate to provide such access. The data cleanup system 134 then commences with processing of source code metadata. In the example of FIG. 6, the data cleanup system 134 is configured to perform an automated, multi-dimensional analysis to detect objects that may be unnecessarily stored based on a lack of usage, a lack of recent updates, or a lack of recent modifications.

In some examples, the data cleanup system 134 automatically performs operation 604, operation 606, and operation 608 at least partially in parallel. At operation 604, the data cleanup system 134 executes a call monitor data check. For example, the production usage analysis component 206 analyzes call monitor results from a cloud database to identify source code objects that have not been executed within a configurable period, such as one year or two release cycles. This check focuses on detecting unused objects in live environments by monitoring production systems.

At operation 606, the data cleanup system 134 executes a repository check. For example, the object history analysis component 208 analyzes a central source code repository table to investigate the development history of objects to ascertain whether they have been updated within a configurable timeframe, such as three years, five years, or ten years.

At operation 608, the data cleanup system 134 executes a reference check. For example, the production usage analysis component 206 performs an automated “where-used-check” or “where-referenced-check” to assess whether a source code object is referenced by other source code objects (e.g., within the same program by another class, within other programs, or by interfaces). This operation can identify dependencies or relationships that may prevent immediate deprecation or deletion.

In some examples, and as shown in FIG. 6, the data cleanup system 134 performs conditional checks based on the findings of operation 604, operation 606, and operation 608. At decision operation 610, the data cleanup system 134 generates a yes/no result (“Result A”) indicating the outcome of the analysis of the call monitor data. At decision operation 612, the data cleanup system 134 generates a yes/no result (“Result B”) indicating the outcome of the analysis of the repository check. At decision operation 614, the data cleanup system 134 generates a yes/no result (“Result C”) indicating the outcome of the reference check.

In some examples, such as where a large number of data objects are simultaneously assessed, the data cleanup system 134 generates prioritization data at operation 616. For example, the data cleanup system 134 ranks data objects as deprecation candidates based on factors such as code size and risk factors (e.g., “Is the object used in any remaining process?” or “Are there downstream dependencies?”). In some examples, the method 600 proceeds further by prioritizing data objects with a higher ranking or priority (e.g., triggering system actions for those items first, before moving on to other items).

At operation 618, the risk classification component 210 of the data cleanup system 134 applies a risk model to generate a risk classification. For example, the data cleanup system 134 loads a preconfigured risk model that defines a plurality of supported risk classifications based on the production usage and object history conditions. The risk model can define various paths or permutations and how to classify risk in each case.

Examples of risk classifications and associated actions, based on an applied risk model, are provided below:
If Result A indicates that the source code object has been executed in the predetermined time period, regardless of Results B and C, the data cleanup system 134 generates a first risk classification that is associated with a high deletion risk. The first risk classification triggers a first system action. An example of the first system action is marking the source code object as “to be retained” at operation 620. In other words, the data cleanup system 134 does not trigger a deletion process based on Result A since the source code object is not a valid target.
If Result A indicates that the source code object has not been executed in the predetermined time period, and Result B indicates that the source code object was updated within the relevant timeframe and/or Result C indicates that the source code object is still referenced by other code, the data cleanup system 134 generates a second risk classification that is associated with a lower risk than the aforementioned “high deletion risk.” The second risk classification triggers a second system action. An example of the second system action is generating a warning or alert and/or adding the source code object to a watchlist at operation 622, as described elsewhere in the present disclosure.
If Result A indicates that the source code object has not been executed in the predetermined time period, Result B indicates that the source code object was not updated within the relevant timeframe, and Result C indicates that the source code object is not referenced by other code, the data cleanup system 134 generates a third risk classification that is associated with a lowest risk. The third risk classification triggers a third system action. An example of the third system action is a forced cleanup instruction at operation 624. For example, the data cleanup system 134 automatically removes the source code object itself or generates, in a test application or interface used by developers, error messages to enforce mandatory cleanup by developers.

The method 600 concludes at closing loop operation 626. The structured flow described with reference to FIG. 6 can effectively integrate with development system features. For example, the features of the data cleanup system 134 can integrate with acceptance checks, identifying inactive code in development systems using configurable thresholds and taking action by forcing cleaning or further evaluation. The data cleanup system 134 can also integrate with production monitoring systems to detect code not executed in production for a configurable timeframe.

Furthermore, the data cleanup system 134 can apply various enforcement mechanisms. For example, if a deletion process is triggered, the data cleanup system 134 first marks the relevant data objects as deprecated. Then, if they are not fully deleted within a predetermined time period (e.g., 6, 12, or 18 months) the data cleanup system 134 generates warnings, tickets, or forced cleanup instructions (e.g., transmitted to the user device 106 of FIG. 1).

Referring to FIG. 3 to FIG. 6, each block of the methods shown and described herein, comprises a computing process that may be performed using a combination of hardware and software. For instance, various functions may be carried out using one or more processors executing instructions stored in one or more memories. The method may be provided by a standalone application, a service or hosted service (standalone or in combination with another hosted service), as a microservice via an API or a plug-in to another product.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one memory that stores instructions; and one or more processors configured by the instructions to perform operations comprising: accessing one or more databases to retrieve metadata for a plurality of data objects; for each data object of the plurality of data objects: processing the metadata to detect that production usage of the data object satisfies at least one first condition and that modification history of the data object satisfies at least one second condition, and after detecting that the at least one first condition and the at least one second condition are satisfied, computing a risk classification for the data object, the risk classification being one of a plurality of supported risk classifications; and automatically triggering a deletion process for the plurality of data objects based on the risk classification.

In Example 2, the subject matter of Example 1 includes, wherein the plurality of data objects comprises a plurality of database tables, processing of the metadata being performed for each database table of the plurality of database tables.

In Example 3, the subject matter of Example 2 includes, wherein the at least one first condition comprises that usage of the database table by source code objects in production is at or below a predetermined threshold, the operations further comprising: programmatically querying one or more data structures to identify at least a subset of the metadata related to the usage of the database table.

In Example 4, the subject matter of Example 3 includes, wherein the at least one second condition comprises that a record count of the database table is at or below a further predetermined threshold and the database table has not been modified within a predetermined time period, the operations further comprising: programmatically querying one or more further data structures to identify at least a further subset of the metadata related to the record count and modification of the database table.

In Example 5, the subject matter of Examples 1~4 includes, wherein computing the risk classification for the data object comprises: determining, based on the metadata, an object type of the data object; automatically selecting the risk classification from among the plurality of supported risk classifications based on both the object type of the data object and detecting that the at least one first condition and the at least one second condition are satisfied.

In Example 6, the subject matter of Examples 1-5 includes, wherein the plurality of data objects comprises a first batch of data objects, the risk classification for the first batch of data objects is a first risk classification that triggers automatic deletion of the first batch of data objects, and the operations further comprising: computing a second risk classification for a second batch of data objects, the second risk classification being one of the plurality of supported risk classifications and being a higher-risk classification than the first risk classification; and flagging the second batch of data objects for further processing prior to deletion of the second batch of data objects, wherein the at least one first condition and the at least one second condition are satisfied for both the first batch of data objects and the second batch of data objects, the second batch of data objects being flagged based on one or more object type differences between the first batch of data objects and the second batch of data objects.

In Example 7, the subject matter of Examples 1-6 includes, wherein the plurality of data objects comprises a plurality of source code objects, processing of the metadata being performed for each source code object of the plurality of source code objects.

In Example 8, the subject matter of Example 7 includes, wherein the at least one first condition comprises that usage of the source code object in production within a predetermined time period is at or below a first threshold, and dependent source code objects associated with the source code object are at or below a second threshold, the operations further comprising: programmatically querying one or more data structures to identify at least a subset of the metadata related to the usage of the source code object and the dependent source code objects.

In Example 9, the subject matter of Example 8 includes, wherein computing the risk classification comprises: loading a preconfigured risk model that defines the plurality of supported risk classifications based at least on the at least one first condition; and automatically applying the preconfigured risk model to obtain the risk classification.

In Example 10, the subject matter of Examples 8-9 includes, wherein the predetermined time period is a first predetermined time period, and the at least one second condition comprises that the source code object has not been modified within a second predetermined time period.

In Example 11, the subject matter of Example 10 includes, wherein computing the risk classification comprises: loading a preconfigured risk model that defines the plurality of supported risk classifications based on the at least one first condition and the at least one second condition; and automatically applying the preconfigured risk model to obtain the risk classification.

In Example 12, the subject matter of Examples 1-11 includes, the operations further comprising: automatically modifying one or more stored data structures to delete the plurality of data objects.

In Example 13, the subject matter of Examples 1-12 includes, the operations further comprising: processing the metadata to identify respective sizes of the plurality of data objects; computing a prioritization for one or more data objects in the plurality of data objects based on the respective sizes; and performing the deletion process based on the prioritization.

In Example 14, the subject matter of Examples 1-13 includes, the operations further comprising: updating the one or more databases to flag the plurality of data objects as deprecated; and transmitting, to a user computing device, an alert indicative of flagging of the plurality of data objects as deprecated.

Example 15 is a computer-implemented method performed by a computer system comprising a memory and at least one hardware processor, the computer-implemented method comprising: accessing one or more databases to retrieve metadata for a plurality of data objects; for each data object of the plurality of data objects: processing the metadata to detect that production usage of the data object satisfies at least one first condition and that modification history of the data object satisfies at least one second condition, and after detecting that the at least one first condition and the at least one second condition are satisfied, computing a risk classification for the data object, the risk classification being one of a plurality of supported risk classifications; and automatically triggering a deletion process for the plurality of data objects based on the risk classification.

In Example 16, the subject matter of Example 15 includes, wherein the plurality of data objects comprises a plurality of database tables, processing of the metadata being performed for each database table of the plurality of database tables, wherein the at least one first condition comprises that usage of the database table by source code objects in production is at or below a predetermined threshold, and the computer-implemented method further comprising: programmatically querying one or more data structures to identify at least a subset of the metadata related to the usage of the database table.

In Example 17, the subject matter of Example 16 includes, wherein the at least one second condition comprises that a record count of the database table is at or below a further predetermined threshold and the database table has not been modified within a predetermined time period, the computer-implemented method further comprising: programmatically querying one or more further data structures to identify at least a further subset of the metadata related to the record count and modification of the database table.

In Example 18, the subject matter of Examples 15-17 includes, wherein the plurality of data objects comprises a plurality of source code objects, processing of the metadata being performed for each source code object of the plurality of source code objects, wherein the at least one first condition comprises that usage of the source code object in production within a predetermined time period is at or below a first threshold, and dependent source code objects associated with the source code object are at or below a second threshold, the computer-implemented method further comprising: programmatically querying one or more data structures to identify at least a subset of the metadata related to the usage of the source code object and the dependent source code objects.

In Example 19, the subject matter of Example 18 includes, wherein the predetermined time period is a first predetermined time period, and the at least one second condition comprises that the source code object has not been modified within a second predetermined time period.

Example 20 is one or more non-transitory computer-readable media storing computer-executable instructions that, when executed by a computing system, cause the computing system to perform operations comprising: accessing one or more databases to retrieve metadata for a plurality of data objects; for each data object of the plurality of data objects: processing the metadata to detect that production usage of the data object satisfies at least one first condition and that modification history of the data object satisfies at least one second condition, and after detecting that the at least one first condition and the at least one second condition are satisfied, computing a risk classification for the data object, the risk classification being one of a plurality of supported risk classifications; and automatically triggering a deletion process for the plurality of data objects based on the risk classification.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

FIG. 7 is a block diagram of a machine in the example form of a computing system 700, according to some examples, within which instructions 724 may be executed for causing the computing system 700 to perform one or more of the methodologies discussed herein. In some examples, the computing system 700 includes a machine that operates as a standalone device, while in other examples the computing system 700 includes a machine that is connected (e.g., networked) to other machines. The computing system 700 can provide or form part of an operating environment in which aspects of the present disclosure are implemented.

In a networked deployment, a machine may operate in the capacity of a server or a client machine in server-client network environment, or as a peer machine in a peer-to-peer (or distributed) network environment. The machine may be a computer, a tablet, a cellular telephone, a web appliance, or other machine capable of executing instructions (sequential or otherwise) that specify actions to be taken by that machine. It is noted that while components typically related to only a single machine are illustrated in FIG. 7, the term “machine” shall also be taken to include any collection of machines that individually or jointly execute a set (or multiple sets) of instructions to perform any one or more of the methodologies discussed herein. The computing system 700 may thus include multiple connected machines. Computing devices can be connected by a network.

The example computing system 700 includes one or more processor(s) 702 (e.g., a Central Processing Unit (CPU), a Graphics Processing Unit (GPU), or both), a primary or main memory 704, and a static memory 706, which communicate with each other via one or more communication connections 708 (e.g., a bus, controller, or network connection). The computing system 700 may further include one or more output devices, such as a display unit 710 (e.g., a liquid crystal display (LCD) or Light-emitting diode (LED) display).

The computing system 700 also includes one or more input devices, such as an input device 712 (e.g., a keyboard or a touch-sensitive display screen), a navigation device 714 (e.g., a mouse), storage 716, a signal generation device 718 (e.g., a speaker), and a network interface device 720. The storage 716 includes a machine-readable medium 722 on which is stored one or more sets of data structures and instructions 724 (e.g., software) embodying or utilized by one or more of the methodologies or functions described herein. The instructions 724 may also reside, completely or at least partially, within the main memory 704 or within the processor(s) 702 during execution thereof by the computing system 700, with the main memory 704 and the processor(s) 702 also each constituting a machine-readable medium 722.

While the machine-readable medium 722 is shown in accordance with some examples to be a single medium, the term “machine-readable medium” may include a single medium or multiple media (e.g., a centralized or distributed database, or associated caches and servers) that store the one or more instructions 724 or data structures. The term “machine-readable medium” shall also be taken to include any tangible medium that is capable of storing, encoding, or carrying instructions 724 for execution by the machine and that cause the machine to perform any one or more of the methodologies of the present disclosure, or that is capable of storing, encoding, or carrying data structures utilized by or associated with such instructions 724. The term “machine-readable medium” shall accordingly be taken to include, but not be limited to, solid-state memories, and optical and magnetic media. Specific examples of a machine-readable medium 722 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

The instructions 724 may further be transmitted or received over a communications network 726 using a transmission medium. The instructions 724 may be transmitted using the network interface device 720 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding, or carrying instructions 724 for execution by the machine, and includes digital or analog communications signals or other intangible media to facilitate communication of such software.

Typically, operating system software (not shown) provides an operating environment for software executing in the computing system 700, and coordinates activities of the components of the computing system 700. One or more API calls may be made between components of the computing system 700, or between a component of the computing system 700 and an external component, based on user input received at the computing system 700.

As used herein, the term “processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a CPU, a Reduced Instruction Set Computing (RISC) Processor, a Complex Instruction Set Computing (CISC) Processor, a GPU, a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor may be emulated in software, running on a physical processor, as a virtual processor or virtual circuit. The virtual processor may behave like an independent processor but is implemented in software rather than hardware.

Operations of example methods described herein may be performed, at least partially, by one or more processors that are temporarily configured (e.g., by software) or permanently configured to perform the relevant operations. The performance of certain of the operations may be distributed among the one or more processors, not only residing within a single machine, but deployed across a number of machines. A hardware-implemented component for performing method operations may comprise dedicated circuitry or logic that is permanently configured (e.g., as a special-purpose processor, such as an FPGA or an ASIC) to perform certain operations. A hardware-implemented component may also comprise programmable logic or circuitry (e.g., as encompassed within a general-purpose processor or another programmable processor) that is temporarily configured by software to perform certain operations.

One or more processors may operate to support performance of the relevant operations in a “cloud computing” environment or as a “software as a service (Saas).” For example, at least some of the operations may be performed by a group of computers (as examples of machines including processors), these operations being accessible via a network (e.g., the Internet) and via one or more appropriate interfaces (e.g., APIs). In practice, cloud-based, on-premises-based, or hybrid scenarios can be supported in some examples.

Examples may be implemented in digital electronic circuitry, or in computer hardware, firmware, or software, or in combinations of them. Examples may be implemented using a computer program product, such as a computer program tangibly embodied in an information carrier (e.g., in a machine-readable medium for execution by, or to control the operation of, data processing apparatus, such as a programmable processor, a computer, or multiple computers). A computer program can be written in any suitable form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

Although specific examples are described herein, it will be evident that various modifications and changes may be made to these examples without departing from the broader spirit and scope of the disclosure. Accordingly, the specification and drawings are to be regarded in an illustrative rather than a restrictive sense. Examples of the subject matter may be referred to herein, individually or collectively, by the term “example” merely for convenience and without intending to voluntarily limit the scope of this application to any single example or concept if more than one is in fact disclosed. Thus, although specific examples have been illustrated and described herein, it should be appreciated that the present disclosure can also cover adaptations, combinations, or variations of various examples, including structural or logical substitutions and changes.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Where the context permits, words using the singular or plural number may also include the plural or singular number, respectively. Except as otherwise indicated, the word “or” in reference to a list of two or more items, covers all of the following interpretations of the word: any one of the items in the list, all of the items in the list, and any combination of the items in the list.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Although some examples, such as those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence. The term “operation” is used to refer to elements in the drawings of this disclosure for ease of reference and it will be appreciated that each “operation” may identify one or more operations, processes, actions, or steps, and may be performed by one or multiple components.

1. A system comprising:
at least one memory that stores instructions; and
one or more processors configured by the instructions to perform operations comprising:
accessing one or more databases to retrieve metadata for a plurality of data objects;
for each data object of the plurality of data objects:
processing the metadata to detect that production usage of the data object satisfies at least one first condition and that modification history of the data object satisfies at least one second condition, the at least one first condition comprising that usage of the data object in a production environment is at or below a predetermined threshold, and the at least one second condition comprising that the data object has not been modified within a predetermined time period, and
based on detecting that the at least one first condition and the at least one second condition are satisfied, computing a risk classification for the data object, the risk classification being one of a plurality of supported risk classifications; and
automatically triggering a deletion process for the plurality of data objects based on the risk classification.

2. The system of claim 1, wherein the plurality of data objects comprises a plurality of database tables, processing of the metadata being performed for each database table of the plurality of database tables.

3. The system of claim 2, wherein the at least one first condition comprises that usage of the database table by source code objects in the production environment is at or below the predetermined threshold, the operations further comprising:
programmatically querying one or more data structures to identify at least a subset of the metadata related to the usage of the database table.

4. The system of claim 3, wherein the at least one second condition comprises that a record count of the database table is at or below a further predetermined threshold and the database table has not been modified within the predetermined time period, the operations further comprising:
programmatically querying one or more further data structures to identify at least a further subset of the metadata related to the record count and modification of the database table.

5. The system of claim 1, wherein computing the risk classification for the data object comprises:
determining, based on the metadata, an object type of the data object; and
automatically selecting the risk classification from among the plurality of supported risk classifications based on the object type of the data object.

6. The system of claim 1, wherein the plurality of data objects comprises a first batch of data objects, the risk classification for the first batch of data objects is a first risk classification that triggers automatic deletion of the first batch of data objects, and the operations further comprising:
computing a second risk classification for a second batch of data objects, the second risk classification being one of the plurality of supported risk classifications and being a higher-risk classification than the first risk classification; and
flagging the second batch of data objects for further processing prior to deletion of the second batch of data objects,
wherein the at least one first condition and the at least one second condition are satisfied for both the first batch of data objects and the second batch of data objects, the second batch of data objects being flagged based on one or more object type differences between the first batch of data objects and the second batch of data objects.

7. The system of claim 1, wherein the plurality of data objects comprises a plurality of source code objects, processing of the metadata being performed for each source code object of the plurality of source code objects.

8. The system of claim 7, wherein the at least one first condition comprises that usage of the source code object in the production environment is at or below a first threshold, and dependent source code objects associated with the source code object are at or below a second threshold, the operations further comprising:
programmatically querying one or more data structures to identify at least a subset of the metadata related to the usage of the source code object and the dependent source code objects.

9. The system of claim 8, wherein computing the risk classification comprises:
loading a preconfigured risk model that defines the plurality of supported risk classifications; and
automatically applying the preconfigured risk model to obtain the risk classification.

10. (canceled)

11. The system of claim 1, wherein computing the risk classification comprises:
loading a preconfigured risk model that defines the plurality of supported risk classifications; and
automatically applying the preconfigured risk model to obtain the risk classification.

12. The system of claim 1, the operations further comprising:
automatically modifying one or more stored data structures to delete the plurality of data objects.

13. The system of claim 1, the operations further comprising:
processing the metadata to identify respective sizes of the plurality of data objects;
computing a prioritization for one or more data objects in the plurality of data objects based on the respective sizes; and
performing the deletion process based on the prioritization.

14. The system of claim 1, the operations further comprising:
updating the one or more databases to flag the plurality of data objects as deprecated; and
transmitting, to a user computing device, an alert indicative of flagging of the plurality of data objects as deprecated.

15. A computer-implemented method performed by a computer system comprising a memory and at least one hardware processor, the computer-implemented method comprising:
accessing one or more databases to retrieve metadata for a plurality of data objects;
for each data object of the plurality of data objects:
processing the metadata to detect that production usage of the data object satisfies at least one first condition and that modification history of the data object satisfies at least one second condition, the at least one first condition comprising that usage of the data object in a production environment is at or below a predetermined threshold, and the at least one second condition comprising that the data object has not been modified within a predetermined time period, and
based on detecting that the at least one first condition and the at least one second condition are satisfied, computing a risk classification for the data object, the risk classification being one of a plurality of supported risk classifications; and
automatically triggering a deletion process for the plurality of data objects based on the risk classification.

16. The computer-implemented method of claim 15, wherein the plurality of data objects comprises a plurality of database tables, processing of the metadata being performed for each database table of the plurality of database tables, wherein the at least one first condition comprises that usage of the database table by source code objects in the production environment is at or below the predetermined threshold, and the computer-implemented method further comprising:
programmatically querying one or more data structures to identify at least a subset of the metadata related to the usage of the database table.

17. The computer-implemented method of claim 16, wherein the at least one second condition comprises that a record count of the database table is at or below a further predetermined threshold and the database table has not been modified within the predetermined time period, the computer-implemented method further comprising:
programmatically querying one or more further data structures to identify at least a further subset of the metadata related to the record count and modification of the database table.

18. The computer-implemented method of claim 15, wherein the plurality of data objects comprises a plurality of source code objects, processing of the metadata being performed for each source code object of the plurality of source code objects, wherein the at least one first condition comprises that usage of the source code object in the production environment is at or below a first threshold, and dependent source code objects associated with the source code object are at or below a second threshold, the computer-implemented method further comprising:
programmatically querying one or more data structures to identify at least a subset of the metadata related to the usage of the source code object and the dependent source code objects.

19. (canceled)

20. One or more non-transitory computer-readable media storing computer-executable instructions that, when executed by a computing system, cause the computing system to perform operations comprising:
accessing one or more databases to retrieve metadata for a plurality of data objects;
for each data object of the plurality of data objects:
processing the metadata to detect that production usage of the data object satisfies at least one first condition and that modification history of the data object satisfies at least one second condition, the at least one first condition comprising that usage of the data object in a production environment is at or below a predetermined threshold, and the at least one second condition comprising that the data object has not been modified within a predetermined time period, and
based on detecting that the at least one first condition and the at least one second condition are satisfied, computing a risk classification for the data object, the risk classification being one of a plurality of supported risk classifications; and
automatically triggering a deletion process for the plurality of data objects based on the risk classification.

21. The computer-implemented method of claim 15, wherein computing the risk classification for the data object comprises:
determining, based on the metadata, an object type of the data object; and
automatically selecting the risk classification from among the plurality of supported risk classifications based on the object type of the data object.

22. The computer-implemented method of claim 15, wherein computing the risk classification comprises:
loading a preconfigured risk model that defines the plurality of supported risk classifications; and
automatically applying the preconfigured risk model to obtain the risk classification.
